(19) United States
(12) Patent Application Publication
(10) Pub. No.: US 2005/0254507 A1
(43) Pub. Date: Nov. 17, 2005

(54) DSL modem apparatus and control method for DSL modem apparatus

(75) Inventors: Takashi Suzuki, Kanagawa (JP); Genzo Takagi, Saitama (JP); Yoshinori Takahashi, Saitama (JP); Toshiko Nishida, Kanagawa (JP); Akihiro Sobue, Tokyo (JP); Nobuhiko Noma, Kanagawa (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/113,029

(22) Filed: Apr. 25, 2005

(30) Foreign Application Priority Data
May 11, 2004 (JP) 2004-141544

(51) Int. Cl. H04L 12/28; H04L 12/56

(52) U.S. Cl. 370/421; 370/463

(57) ABSTRACT

In an ATU-R having established a connection with an ATU-C and being in a state where data communication is enabled, the ATU-R being located at a user's home, a voltage detection circuit detects a connector voltage of a connector to which a network cable of a user side is connected. When the connector voltage is decreased below a predetermined value in a state where power is supplied to an ADSL circuit of the ATU-R, the power supply to the ADSL circuit is stopped while maintaining a function related to detecting the connector voltage and controlling the power supply. The connector voltage is monitored even after the power supply is stopped. When the detected connector voltage becomes greater than the predetermined value, the power supply to the ADSL circuit is resumed.

### BACKGROUND OF THE INVENTION

1. Field of the Invention

The present invention relates to a DSL modem apparatus and a control method for the same, to which the xDSL technology is applied, the technology enabling a high speed communication of several M bits/second even via a cupper wire cable for subscriber lines.

2. Description of Related Art

There is an increasing need for high speed access lines due to the popularity of the Internet. At the same time, more optical fiber cables are introduced to the backbone of the communication carriers, which make use of super high speed lines (gigabit class) in the backbone. However, there are cases where a metal cable for an ordinary telephone is still used for a subscriber line that connects a user's home and a carrier center. Therefore, the xDSL technology has been introduced to enable the high speed communication of several M bits/second via a metal cable.

The ADSL method is one example of the xDSL technology. The ADSL method uses a carrier frequency of 35 kHz or more, which is much higher than a frequency band for telephones (4 kHz or less). Accordingly, it is possible to perform the high speed communication using a telephone line, without hindering the function of the ordinary telephone.

When the ADSL is used, it is common to set up ADSL modems at both sides of the metal cable that connects the user's home and the carrier center. When the ADSL modem setup at the ATU-R side (hereafter referred to as “ATU-R”) is turned on, the ATU-R and the ADSL modem setup at the ATU-C side (hereafter referred to as “ATU-C”) establish synchronization, exchange capabilities, determine communication parameters according to the protocols by the ITU-T recommendation, and thereafter enter into a data communication phase (Showtime) (e.g., Related Art 1).

Recently, it has become a mainstream to have a constant connection from a home-use personal computer (PC) to the Internet. In case of an ADSL Internet connection, the center separates signals prior to an exchange stage to enable the connection to the Internet via a router. The ATU-R operates during the data communication and even in a period where the PC is turned off, in order to receive a control signal transmitted from the ATU-C (e.g., a pilot signal for synchronization).
[Related Art 1] Japanese Patent Laid Open Publication 2003-0873480

However, a certain amount of electric power goes to waste when the ATU-R is left in an operatable condition during the period in which the PC is turned off. The user may turn off the ADSL modem every time the PC is turned off in order to save energy. However, the user must again operate the switch for the ADSL modem every time the user wants to user the PC. Especially, when the ADSL modem and the PC are in separate locations (since the ADSL modem is not necessarily located near the PC), the user must perform a cumbersome task for turning on the ADSL modem.

### SUMMARY OF THE INVENTION

The present invention addresses the above-described problem. The purpose of the invention is to provide a DSL modem apparatus and a control method for the same, which can automatically be turned on/off, according to the operation status of a PC, without imposing the user to operate the switch for the modem, thereby saving the energy consumption.

In the present invention, when a voltage of a connector, to which a network cable at a user's home is connected, is decreased below a predetermined level, the power supply to at least a communication controller is stopped.

The power supply to the communication controller is stopped when the network cable connector voltage is decreased below a predetermined level, which is caused by the power cutoff to the PC connected to the network cable of the user's home. Therefore, it is possible to automatically control the power switch according to the PC operation status, thereby saving the energy consumption.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a functional block diagram illustrating an ADSL modem apparatus according to an embodiment of the present invention;

FIG. 2 illustrates a network configuration between an ATU-C and an ATU-R;

FIG. 3 illustrates a normal sequence between the ATU-C and the ATU-R; and

FIG. 4 is an energy saving sequence between the ATU-C and the ATU-R.

### DETAILED DESCRIPTION OF PREFERRED EMBODIMENTS

An ADSL modem apparatus according to the embodiment of the present invention is explained in the following, in reference to the above-described drawings.

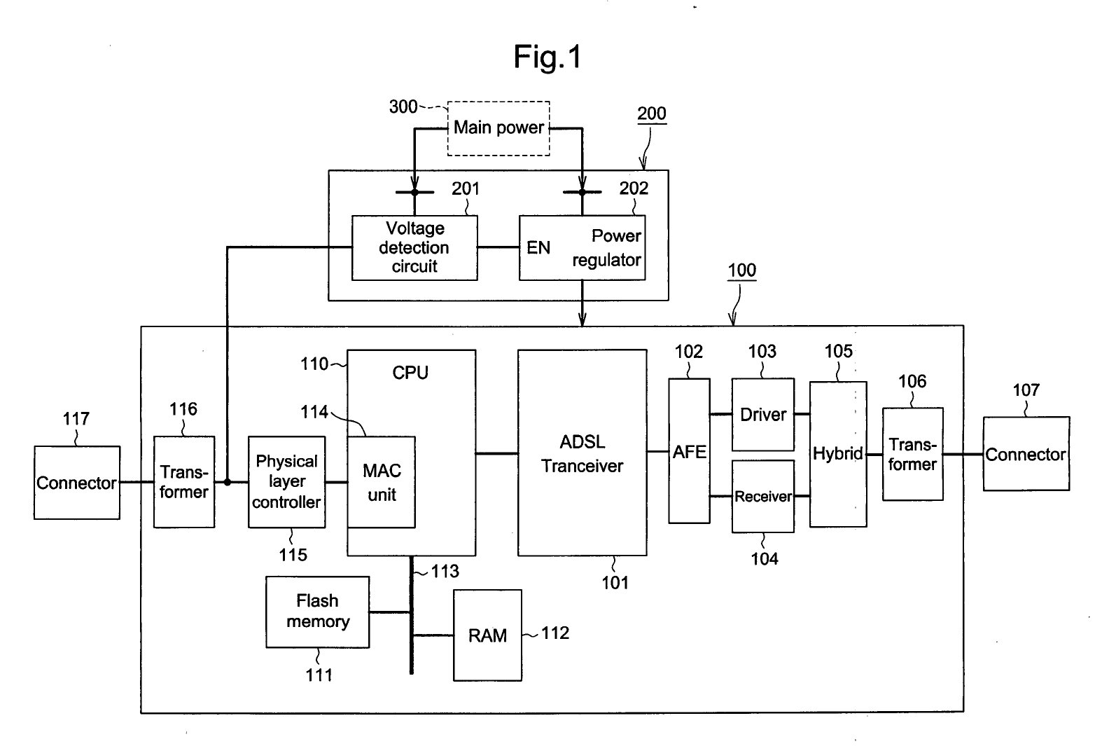

FIG. 1 is a functional block diagram of an ADSL modem apparatus that is located at a user's home side. The ADSL modem apparatus in FIG. 1 includes ADSL circuit 100 and power controller 200. ADSL circuit 100 includes ADSL transceiver 101 that performs a handshake sequence, initialization sequence, and communication control for a data communication phase. Driver 103 and receiver 104 are connected to ADSL transceiver 101, via AFE (analog front end) 102 that performs AD/DA conversion. Driver 103 is a circuit that amplifies a transmission signal (analog) output from AFE 102 to a level that is suitable for a metal cable (subscriber line). Receiver 104 is a circuit that converts the power of a reception signal received from the metal cable (subscriber line) to a level suitable for AFE 102. Driver 103 and receiver 104 are connected to connector 107, via hybrid 105 and transformer 106, the connector being physically connected to the metal cable (subscriber line).

ADSL circuit 100 also includes CPU 100 for an interface with an LAN (Local Area Network; such as an Ethernet located at the user's home). Flash memory 111 and RAM 112 are connected to CPU 110 via bus 113. In this embodiment, the Ethernet is connected to the ADSL modem apparatus. CPU 110 internally houses MAC unit 114 that performs processes such as MAC frame assembly/disassembly (for the flow on the Ethernet) and MAC address recognition. MAC unit 114 is connected to transformer 116 via physical layer controller 115, the physical layer controller 115 controlling, in the physical layer, modulation and other operations employed by the Ethernet. Connector 117 is connected to the network side of transformer 116. A cable of the Ethernet is physically connected to connector 117. As shown in FIG. 1, an Ethernet cable voltage appears at each end of transformer 116 (connector voltage). Power controller 200 includes voltage detection circuit 201 that detects the connector voltage appearing at one end of transformer 116. A personal computer (PC) is connected to the Ethernet cable. When the PC is turned on, a voltage is applied to the Ethernet cable from the PC. When the PC is turned off, the voltage is no longer applied to the Ethernet cable from the PC.

Voltage detection circuit 201 detects whether the PC is turned on, by detecting the connector voltage appearing at one end of transformer 116. When the detected voltage has a value equivalent to the one for when the PC is turned on (at or greater than a predetermined level), voltage detection circuit 201 outputs an ON signal (active) to an enable terminal (EN) of power regulator 202. On the other hand, when the detected voltage has a value equivalent to the one for when the PC is turned off (smaller than the predetermined level), voltage detection circuit 201 outputs an OFF signal (non-active) to the enable terminal (EN) of power regulator 202. The predetermined value is set at a level where it is possible to identify whether the PC is turned on/off.

Power regulator 202 provides power by converting a power voltage provided from main power 300 into a voltage appropriate for each unit of ADSL circuit 100. Power regulator 202 provides power to units of ADSL circuit 100 while the ON signal (active) is input to the enable terminal (EN). However, power regulator 202 stops the power supply to units of ADSL circuit 100 while the OFF signal (non-active) is input. In other words, when the PC connected to the Ethernet cable is turned on, the power is supplied to ADSL circuit 100. When the PC is turned off, the power supply is stopped. In addition, the configuration for controlling the supply of power to ADSL circuit 100 according to the power status of the PC is not limited to what is described above.

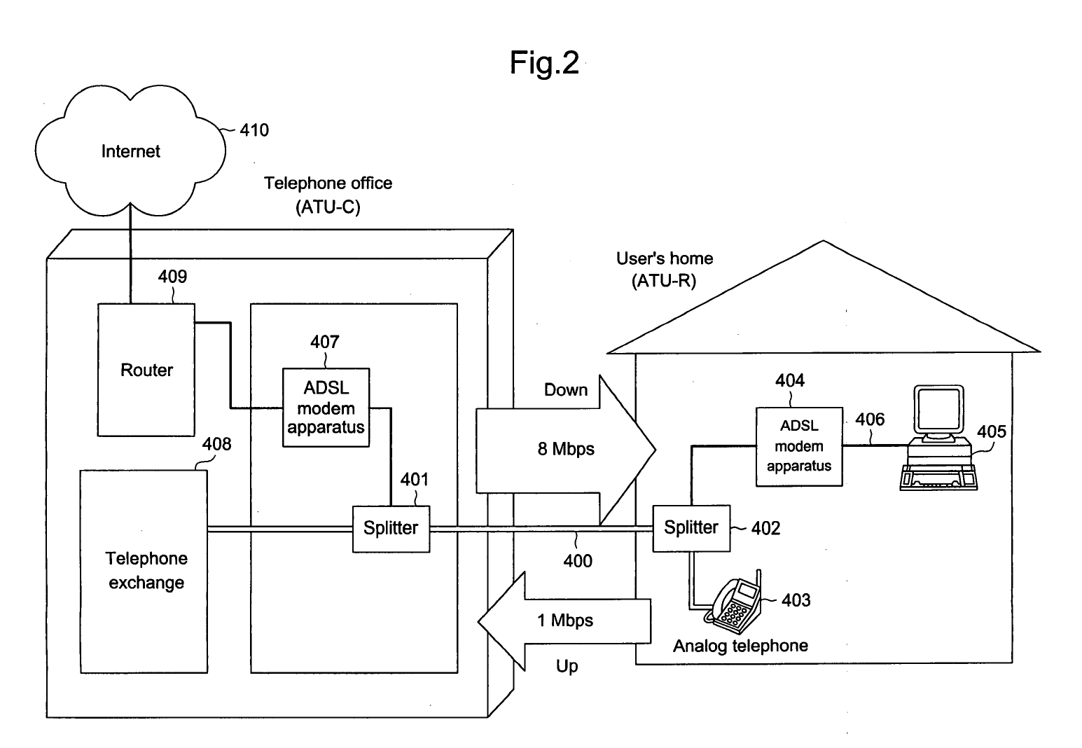

FIG. 2 illustrates an example of a system configuration having the ATU-C and ATU-R, to which the above described ADSL modem apparatus is applied. In general, metal cable 400 connects the ATU-C (center side) and ATU-R (user's home), the cable having already been used as a general subscriber line. At both ends of metal cable 400, splitters 401 and 402 are attached. Splitters 401 and 402 split the communication band into a voice band to be used for the telephone line and a data communication band to be used for the ADSL data communication. If there is no need to split the communication band, the splitters are not necessary. Analog telephone 403 and ADSL modem apparatus 404 are connected to splitter 402 at the ATU-R side. ADSL modem apparatus 404 has the configuration shown in FIG. 1. PC 405 located at the ATU-R side is connected to ADSL modem apparatus 404 via Ethernet cable 406, which means that one end of Ethernet cable 406 is physically connected to connector 117 shown in FIG. 1.

ADSL modem apparatus 407 and telephone exchange 408 are connected to splitter 401 at the ATU-C side. Signals for the voice band split by splitters 401 is output to telephone exchange 408, while signals for the ADSL communication band (set higher than the voice band) is output to ADSL modem apparatus 407. Although ADSL modem apparatus 407 has the basic configuration shown in FIG. 1, it is unnecessary to have power controller 200. This is because ADSL modem apparatus 407 at the center side is not turned off, as a basic rule, in order to respond to any detected signals transmitted from the ATU-R side. ADSL modem apparatus 407 is connected to Internet 410 via router 409.

Next, an operation of the present embodiment having the above described configuration is illustrated in the following.

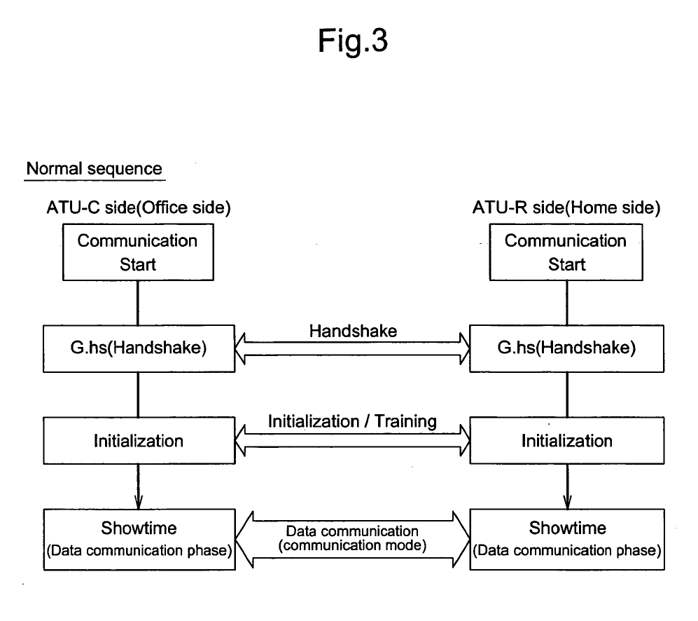

FIG. 3 illustrates a normal sequence starting from when an ADSL modem apparatus is turned on and until a data communication is established. When ADSL modem apparatus 404 at the ATU-R side is turned on, ADSL modem apparatus 404 at the ATU-R side and ADSL modem apparatus 407 at the ATU-C side perform a handshake sequence, in which types and capabilities of both sides are exchanged. When the handshake sequence is completed, an initialization sequence is performed. In the initialization sequence, the line condition is checked and trained, and a communication parameter for the ADSL communication is determined. When the initialization sequence is completed, the data communication is enabled. ADSL transceivers 101 in both ADSL modem apparatus 404 and 407 mainly perform the above handshake and initialization sequences.

Conventionally, when PC 405 at the ATU-R side is constantly connected to the Internet, ADSL modem apparatuses 404 and 407 are in a state where the data communication is always enabled. In the present embodiment, however, when PC 405 is turned off, the power supply to ADSL modem apparatus 405 is stopped, thereby canceling the state where the data communication is enabled.

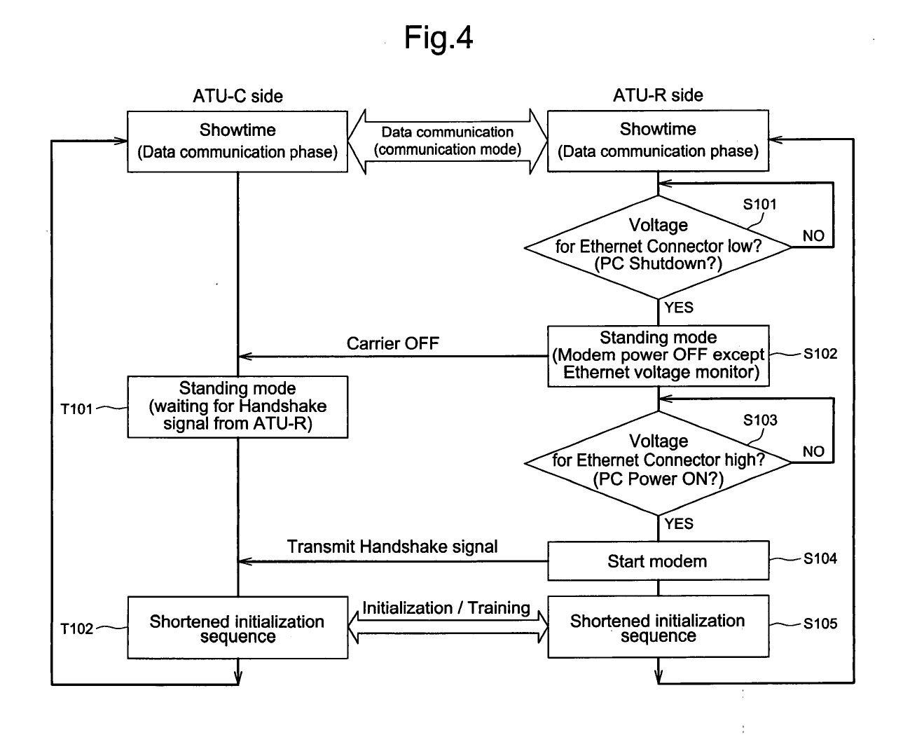

FIG. 4 illustrates an operation when PC 404 at the ATU-R side is turned off from the state where the data communication is enabled. In ADSL modem apparatus 404 at the ATU-R side, power controller 200 constantly detects the connector voltage (voltage at one end of transformer 116) of Ethernet cable 406. When it is detected that the detected voltage is lowered to a level equivalent to the voltage for when PC 405 is turned off (S101), ADSL circuit 100 is transitioned to a standby mode (S102). During the standby mode, the power to all units excluding power controller 200 is turned off, the power controller monitoring the connector voltage of Ethernet cable 406. In particular, voltage detection circuit 201 of power controller 200 converts the output signal (to the enable terminal (EN) of power regulator 202) into non-active from active. Accordingly, during a period in which the enable terminal (EN) is non-active, power regulator 202 stops the power supply to ADSL circuit 100. Therefore, it is possible to prevent a wasteful power consumption that supplies power to ADSL circuit 100 even though PC 405 is turned off at the user's home.

When the power supply to ADSL circuit 100 (at the ATU-R side) is stopped, the ATU-C side no longer receives signals from the ATU-R side (carrier OFF). As a result, ATU-C transitions into the standby mode that waits for a reception of a handshake signal from the ATU-R (T101). In this standby mode, the transmission and reception of signals to/from the ATU-R is completely stopped.

In power controller 200 at the AUT-R, voltage detection circuit 201 operates even during the standby mode (S102). In this illustration, the user turns on PC 405 connected to the ATU-R, at which the power supply to ADSL circuit 100 is stopped.

When PC 405 is turned on, the connector voltage detected by voltage detection circuit 201 is changed to a value that indicates that PC 405 is turned on. Upon detecting that PC 405 is turned on from the detected voltage (S103), voltage detection circuit 201 converts the output signal (to the enable terminal (EN) of power regulator 202) into active from non-active, in order to resume the power supply to ADSL circuit 100. When the power is turned on, ADSL transceiver 101 of ADSL circuit 100 transmits a handshake signal to the ATU-C and starts the handshake sequence (S104). Upon completing the handshake sequence, the ATU-C and ATU-R perform the initialization sequence to initialize themselves and determine the communication parameter (S105 and T102) to enter into the data communication phase.

In the present embodiment, a shortened sequence is applied for the initialization sequence at S105 and T102. In particular, the communication parameter determined during the previous initialization sequence is stored and used again in order to omit some of the steps executed during a normal initialization sequence. Then, sequences for establishing synchronization and others are executed. In this example, the initialization sequence is shortened under the assumption that the line condition does not greatly change. However, a normal (not shortened) initialization sequence can be applied.

According to the present embodiment, the connector voltage of the Ethernet cable connected to the ATU-R is monitored. When it is detected that PC 405 connected to the Ethernet cable is shut off, the power supply to ADSL circuit 100 is also stopped. Therefore, it is possible to prevent the wasteful power consumption during a period in which communication with ATU-C is not performed because PC 405 is turned off.

In the above description, ADSL method is used for the illustration. However, the present invention can be applied to other DSL methods.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2004-141544 filed on May 11, 2004, entire content of which is expressly incorporated by reference herein.

1. A DSL modem apparatus comprising:
a communication controller that establishes a connection with a DSL modem apparatus at a center side and prepares a state where data communication is enabled; and
a power controller that stops power supplied to said communication controller, when a connector voltage of a connector is decreased below a predetermined value in a state where power is supplied to said communication controller, the connector connecting to a network cable at a user side.

2. The DSL modem apparatus according to claim 1, wherein said power controller monitors the connector voltage even after the power supply to said communication controller is stopped, and wherein, when a detected connector voltage becomes greater than the predetermined value, the power supply to said communication controller is resumed.

3. The DSL modem apparatus according to claim 2, wherein said communication controller stores a communication parameter, the parameter being obtained when the connection with the DSL modem apparatus at the center side is established, and wherein, when the power supply is resumed, a part of a sequence for establishing a connection is omitted by applying the stored communication parameter.

4. A control method for a DSL modem apparatus at a user side, the apparatus establishing a connection with a DSL modem apparatus at a center side and being in a state where data communication is enabled, the method comprising:
detecting a connector voltage of a connector connected to a network cable of the user side; and
stopping power supplied to the DSL modem apparatus at the user side, when the connector voltage of the connector is decreased below a predetermined value in a state where power is supplied to the DSL modem apparatus at the user side, while maintaining a function related to detecting the connector voltage and controlling the power supply.

5. The method for the DSL modem apparatus at the user side according to claim 4, the method further comprising:
monitoring the connector voltage even after the power supply to the DSL modem apparatus at the user side is stopped, and
resuming the power supply to the DSL modem apparatus at the user side, when a detected connector voltage becomes greater than the predetermined value.
